(19) United States
(12) Patent Application Publication
(10) Pub. No.: US 2025/0094248 A1
(43) Pub. Date: Mar. 20, 2025

(54) CUSTOMIZABLE DATA PAYLOAD PROCESSING AND HANDLING FOR DOWNSTREAM APPLICATION WORKFLOWS

(71) Applicant: Optum, Inc., Minnetonka, MN (US)

(72) Inventors: Sumit Lahiri, Lincolnshire, IL (US); David Andrew Potochniak, Raleigh, NC (US); Amit Mittal, Ghaziabad (IN); Ravi Prakash Tripathi, Hyderabad (IN); Bikas Chaudhuri, Andover, MA (US); Jeffrey A. Modder, Hastings, MN (US)

(21) Appl. No.: 18/521,518

(22) Filed: Nov. 28, 2023

Related U.S. Application Data
(60) Provisional application No. 63/583,972, filed on Sep. 20, 2023.

(51) Int. Cl. G06F 9/54

(52) U.S. Cl. CPC G06F 9/542; G06F 9/547

(57) ABSTRACT

Various embodiments of the present disclosure provide methods, apparatus, systems, computing devices, computing entities, and/or the like for analyzing performance and operation of one or more downstream applications by: (i) asynchronously capturing one or more event message payloads, (ii) providing, using a producer client, the one or more event message payloads as an input topic to a streaming server that is configured to provide, to one or more consumer clients, (1) one or more input topic streams that comprises the one or more event message payloads and (2) one or more output topic streams, (iii) applying a transformation to the one or more event message payloads received from the input topic by a consumer client of the one or more consumer clients, and (iv) providing, using the producer client, one or more transformed event message payloads as an output topic to the streaming server.

### CROSS REFERENCE TO RELATED APPLICATION

This application claims the priority of U.S. Provisional Application No. 63/583,972, entitled “CUSTOMIZABLE DATA PAYLOAD PROCESSING AND HANDLING FOR DOWNSTREAM APPLICATION WORKFLOWS,” filed on Sep. 20, 2023, the disclosure of which is hereby incorporated by reference in its entirety.

### BACKGROUND

Various embodiments of the present disclosure address technical challenges related to asynchronous processing of application data streams that are detached from an application's traffic data pipeline to address the efficiency and reliability shortcomings of existing data analysis workflow solutions.

A traditional enterprise system may comprise various system components for exchanging a variety of data sets and utilizing interoperability standards through different technology solutions (e.g., Suitable Medical Apps, Reusable Technology (SMART)-on-Fast Healthcare Interoperability Resources (FHIR) applications, FHIR service application programming interfaces (APIs) in a healthcare-based system, etc.) to support downstream applications. Some traditional enterprise systems may further comprise workflows for generating insights on the performance of various components within the enterprise systems for decision and supporting evidence-based actions that may improve day-to-day operations. For example, a traditional enterprise system may comprise different data repositories that contain different data assets comprising information about how various system components are operating. However, the dearth of a standard for enterprise reporting is a problem across the health information exchange (HIE) industry. The current healthcare information technology (IT) industry is more focused on improving how data is exchanged and interactions associated thereof, rather than implementing reporting of operating data.

A traditional enterprise system may comprise disparate system components, such as applications or software from different vendors, at least some of which are integrated with a common communication platform to communicate with each other. Various data communication channels associated with the disparate system components may be received by a common communication platform to support multiple downstream applications. However, traditional operation reporting solutions that may be used to generate insight data for multiple downstream applications suffer from siloed and inconsistent reporting, manual footprints and interventions, batch mode of reporting and time lag, source data with various structures, content, and forms, and a need for customized reports and insights from complex, inherently nested data.

Various embodiments of the present disclosure make important contributions to traditional data analysis workflow techniques by addressing these technical challenges, among others.

### BRIEF SUMMARY

In general, various embodiments of the present disclosure provide methods, apparatus, systems, computing devices, computing entities, and/or the like for handling data used in data analysis workflows.

Various embodiments of the present disclosure make important technical contributions to data analysis workflows that address the efficiency and performance shortcomings of existing data analysis workflows. As described herein, event message payloads may have complex nested structures that are not optimal for running analytics on or for deriving metrics from. Although event message payloads may be necessary for performing day-to-day operations, transformed event message payloads comprising a relatively flattened data structure and selected data fields may be more appropriate for data analysis. However, the addition of a data analysis workflow to a production computing system may negatively affect the performance of downstream applications. Accordingly, by performing asynchronous capture and streaming of event message payloads from an applications traffic data pipeline of the production computing system, the techniques described herein improve computational and bandwidth efficiency and/or speed of a computing system.

In some embodiments, a computer-implemented method comprises receiving, by one or more processors, one or more event message payloads associated with one or more messages between one or more application programming interfaces or integrator elements and one or more downstream applications; providing, by the one or more processors and using a producer client, the one or more event message payloads as an input topic to a streaming server that is configured to provide, to one or more consumer client, (1) one or more input topic streams that comprises the one or more event message payloads and (2) one or more output topic streams; receiving, by the one or more processors and using a consumer client of the one or more consumer clients, the one or more event message payloads from the one or more input topic streams; generating, by the one or more processors, one or more transformed event message payloads by applying one or more data transformation rules to the one or more event message payloads received from the one or more input topic streams; and providing, by the one or more processors and using the producer client, the one or more transformed event message payloads as an output topic to the streaming server.

In some embodiments, a computing system comprising memory and one or more processors communicatively coupled to the memory, the one or more processors configured to receive one or more event message payloads associated with one or more messages between one or more application programming interfaces or integrator elements and one or more downstream applications; provide, using a producer client the one or more event message payloads as an input topic to a streaming server that is configured to provide, to one or more consumer clients, (1) one or more input topic streams that comprises the one or more event message payloads and (2) one or more output topic streams; receive, using a consumer client of the one or more consumer clients, the one or more event message payloads from the one or more input topic streams; generate one or more transformed event message payloads by applying one or more data transformation rules to the one or more event message payloads received from the one or more input topic streams; and provide, using the producer client the one or more transformed event message payloads as an output topic to the streaming server.

In some embodiments, one or more non-transitory computer-readable storage media including instructions that, when executed by one or more processors, cause the one or more processors to receive one or more event message payloads associated with one or more messages between one or more application programming interfaces or integrator elements and one or more downstream applications; provide, using a producer client, the one or more event message payloads as an input topic to a streaming server that is configured to provide, to one or more consumer clients, (1) one or more input topic streams that comprises the one or more event message payloads and (2) one or more output topic streams; receive, using a consumer client of the one or more consumer clients, the one or more event message payloads from the one or more input topic streams; generate one or more transformed event message payloads by applying one or more data transformation rules to the one or more event message payloads received from the one or more input topic streams; and provide, using the producer client, the one or more transformed event message payloads as an output topic to the streaming server.

### BRIEF DESCRIPTION OF THE DRAWINGS

FIG. 1 provides an example overview of an architecture in accordance with some embodiments of the present disclosure.

FIG. 2 provides an example data analysis computing entity in accordance with some embodiments of the present disclosure.

FIG. 3 provides an example client computing entity in accordance with some embodiments of the present disclosure.

FIG. 4 is a flowchart diagram of an example process for configuring topic streams of a streaming server in accordance with some embodiments of the present disclosure.

FIG. 5 is a flowchart diagram of an example process for handling outsized event message payloads in accordance with some embodiments of the present disclosure.

FIG. 6 depicts an operational example of a data workflow architecture 600 in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

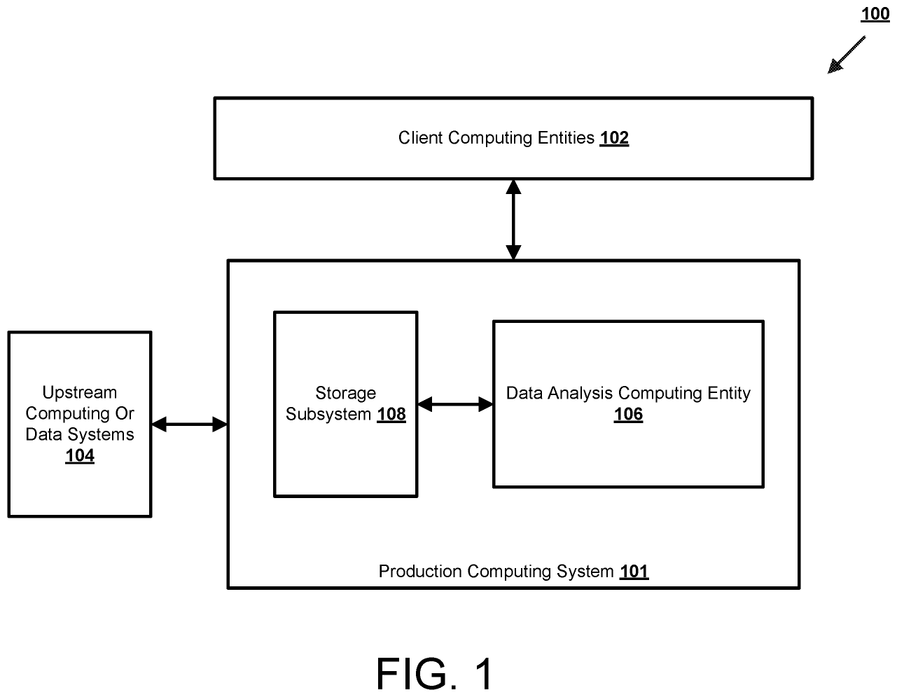

FIG. 1 provides an example overview of an architecture 100 in accordance with some embodiments of the present disclosure. The architecture 100 includes a production computing system 101 configured to receive data analysis requests from client computing entities 102, process the data analysis requests to analyze data (e.g., event message payloads associated with upstream computing or data systems 104), analyze the data, generate analytics and/or predictions, and provide the analytics and/or predictions to the client computing entities 102, which may automatically initiate performance of prediction-based actions based on the generated analytics and/or predictions. The example architecture 100 may be used in a plurality of domains and not limited to any specific application as disclosed herewith. The plurality of domains may include banking, healthcare, industrial, manufacturing, education, retail, to name a few.

An example of a prediction-based action that may be performed using the production computing system 101 comprises receiving a request for analyzing and/or predicting operation or performance of one or more downstream applications, generating analytics and/or predictions based on event message payloads associated with the one or more downstream applications, and displaying the analytics and/or predictions on a user interface. Other examples of prediction-based actions comprise generating a diagnostic report, displaying/providing resources, generating, and/or executing action scripts, generating alerts or reminders, or generating one or more electronic communications based on the analytics and/or predictions.

In accordance with various embodiments of the present disclosure, a data analysis workflow for streaming and downstream analytics processing is executed on a production computing system by performing asynchronous capture and streaming of event message payloads from an applications traffic data pipeline of the production computing system. The asynchronous capture and streaming of event message payloads are decoupled from an applications traffic data pipeline of the production computing system. As such, operations of the disclosed data analysis workflow may be executed in a separate data pipeline and prevented from hindering the performance of applications executing on the production computing system. On-the-fly transformation of data may also be performed to improve analysis of operation or performance of one or more downstream applications. Additionally, streaming of larger event message payloads may also be handled by archiving the larger event message payloads and streaming a reference to the archived larger event message payloads to reduce network bandwidth utilization for streaming the larger event message payloads. The aforementioned techniques will lead to improved performance of a computing system executing both downstream applications and data analysis workflows. Accordingly, the techniques described herein improve computational and bandwidth efficiency and/or speed of a computing system.

In some embodiments, production computing system 101 may communicate with at least one of the client computing entities 102 and upstream computing or data systems 104 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The production computing system 101 may include a data analysis computing entity 106 and a storage subsystem 108. The data analysis computing entity 106 may be configured to receive data analysis requests from client computing entities 102, process the data analysis requests to analyze data (e.g., event message payloads associated with upstream computing or data systems 104), analyze the data, generate analytics and/or predictions, and provide the analytics and/or predictions to the client computing entities 102, which may automatically initiate performance of prediction-based actions based on the generated analytics and/or predictions.

The upstream computing or data systems 104 may be configured to communicate or exchange data communications with one or more downstream applications executing on production computing system 101. In one example embodiment, upstream computing or data systems 104 comprise digital records systems, or user interfaces or API services associated with the digital records systems. A digital records system may be configured to store and process electronic data records, such as electronic medical records (EMR) or electronic health records (EHR). One or more downstream applications executing on production computing system 101 may interact with or exchange data from upstream computing or data systems 104. According to various embodiments of the present disclosure, data exchanged between the one or more downstream applications executing on production computing system 101 and upstream computing or data systems 104 are asynchronous captured by data analysis computing entity 106 as event message payloads that may be streamed to other components on production computing system 101.

The storage subsystem 108 may be configured to store input data used by the data analysis computing entity 106 to perform various data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### A. Example Data Analysis Computing Entity

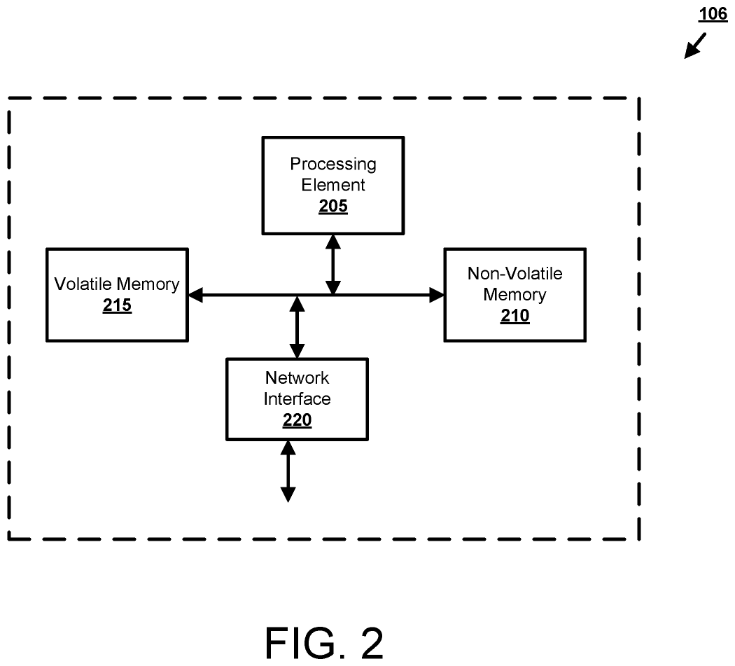

FIG. 2 provides an example data analysis computing entity 106 in accordance with some embodiments of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In some embodiments, these functions, operations, and/or processes may be performed on data, content, information, and/or similar terms used herein interchangeably.

As shown in FIG. 2, in some embodiments, the data analysis computing entity 106 may include, or be in communication with, one or more processing elements 205 (also referred to as processors, processing circuitry, and/or similar terms used herein interchangeably) that communicate with other elements within the data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the data analysis computing entity 106 may further include, or be in communication with, non-volatile media (also referred to as non-volatile storage, memory, memory storage, memory circuitry, and/or similar terms used herein interchangeably). In some embodiments, the non-volatile storage or memory may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the data analysis computing entity 106 may further include, or be in communication with, volatile media (also referred to as volatile storage, memory, memory storage, memory circuitry, and/or similar terms used herein interchangeably). In some embodiments, the volatile storage or memory may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the data analysis computing entity 106 with the assistance of the processing element 205 and operating system.

As indicated, in some embodiments, the data analysis computing entity 106 may also include one or more network interfaces 220 for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the data analysis computing entity 106 may include, or be in communication with, one or more input elements, such as a keyboard input, a mouse input, a touch screen/display input, motion input, movement input, audio input, pointing device input, joystick input, keypad input, and/or the like. The data analysis computing entity 106 may also include, or be in communication with, one or more output elements (not shown), such as audio output, video output, screen/display output, motion output, movement output, and/or the like.

### B. Example Client Computing Entity

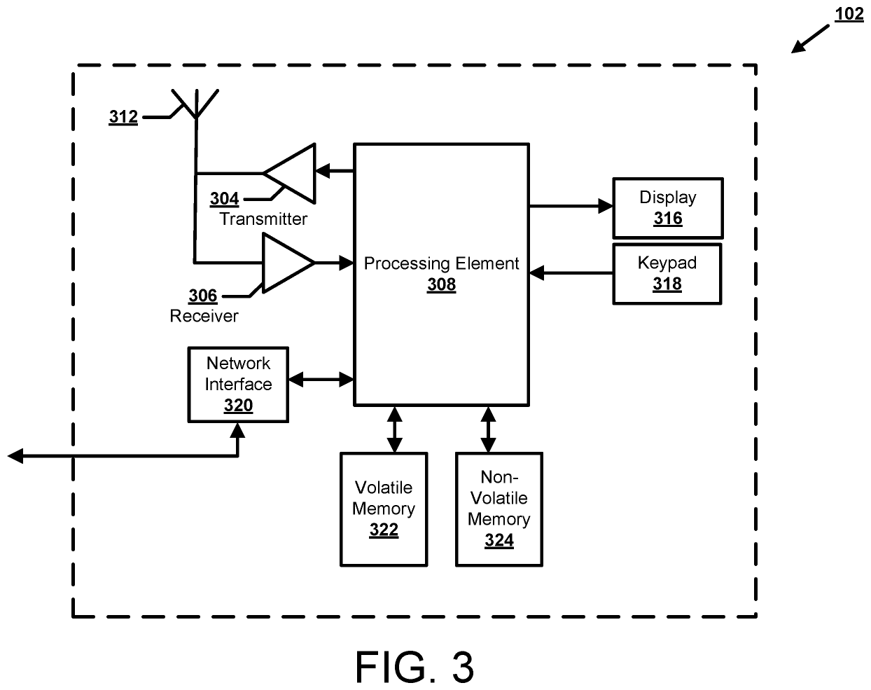

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the data analysis computing entity 106. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the data analysis computing entity 106 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the data analysis computing entity 106, as described herein. The user input interface may comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the client computing entity 102 or accessible through a browser or other user interface for communicating with the data analysis computing entity 106 and/or various other computing entities.

In another embodiment, the client computing entity 102 may include one or more components or functionalities that are the same or similar to those of the data analysis computing entity 106, as described in greater detail above. As will be recognized, these architectures and descriptions are provided for example purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Examples of Certain Terms

In some embodiments, the term “event message payload” refers to a data construct that describes data content comprising a request or response message that is transmitted between one or more APIs or integrator elements and one or more downstream applications within an application layer. In some embodiments, an event message payload is associated with an interaction with downstream computing processes or data systems comprising various data communication channels. In one example embodiment, an event message payload is associated with a digital records system comprising electronic data records, such as EMRs and/or EHRs. In another example embodiment, an event message payload is associated with a user interface or API service associated with a digital records system. In some embodiments, an event message payload comprises a hypertext transfer protocol (HTTP) message comprising one or more HTTP headers. According to various embodiments of the present disclosure, one or more event message payloads may be received via an event message interceptor associated with an integration services application layer interface that is communicatively coupled to one or more APIs or integrator elements. According to various embodiments of the present disclosure, one or more event message payloads may be asynchronously streamed, e.g., for analysis and/or reporting, in a manner that does not interfere negatively with response service level agreement (SLA) of one or more downstream applications in the application layer.

In some embodiments, the term “integration services application layer interface” refers to an interface on an application layer that is communicatively coupled to one or more APIs or integrator elements. An integration services application layer interface may exchange data with one or more APIs or integrator elements to facilitate interoperability of one or more downstream applications with one or more upstream computing or data systems (e.g., comprising one or more upstream applications). In some embodiments, the integration services application layer interface aggregates data transferred between one or more downstream applications and one or more upstream computing or data systems. In one example embodiment, an integration services application layer interface comprises an EMR integration services layer (EISL) or a FHIR façade. According to various embodiments of the present disclosure, data received by the integration services application layer interface may be captured as one or more event message payloads from the integration services application layer interface in real-time by an event message interceptor and transmitted to a producer client for writing (assigning or publishing) to topics on a streaming server.

In some embodiments, the term “upstream application” refers to software, code, or instructions executing on an upstream computing or data system. An upstream application may be configured to perform one or more tasks, such as generating data or storing data. Data generated and/or stored by an upstream application may be used by one or more downstream applications executing on a production computing system. In some embodiments, an upstream application receives data from and/or transmits data to one or more downstream applications executing on a production computing system. In some embodiments, an upstream application may comprise a digital records system, or user interface or API service associated with the digital records system.

In some embodiments, the term “downstream application” refers to software, code, or instructions executing on a production computing system. A downstream application may be configured to perform one or more tasks associated with data generated or stored by one or more upstream applications. In some embodiments, a downstream application interacts with one or more upstream applications via requesting data from, receiving data from, and/or transmitting data to one or more upstream computing or data systems comprising the one or more upstream applications.

In some embodiments, the term “event message interceptor” refers to software, code, or instructions that may be coupled or added to an integration services application layer interface. According to various embodiments of the present disclosure, an event message interceptor is configured to (i) intercept or capture event message payloads communicated or transmitted between the integration services application layer interface and one or more APIs or integrator elements and (ii) forward the event message payloads to a producer client.

In some embodiments, the terms “application programming interface (API)” or “integrator element” refer to intermediary components that facilitate communication between one or more upstream computing or data systems with a production computing system via an integration services application layer interface. An API or integrator element may comprise a set of definitions, rules, and/or protocols for enabling one or more upstream computing or data systems to communication with the integration services application layer interface. Examples of an API or integrator element include, but are not limited to, graphical user interfaces, software widgets, interoperability servers, interchange processing layers, communication protocol APIs, file APIs, or any API associated with upstream computing or data systems. In some embodiments, various communication channels associated with the APIs or integrator elements may communicate with an integration services application layer interface via a standardized communication protocol data structure, such as FHIR.

In some embodiments, the term “producer client” refers to a computing entity, e.g., hardware, software, or a combination thereof, that provides (e.g., by publishing, writing, etc.) data to a streaming server. A producer client, for example, may provide message data (e.g., event message payloads, transformed event message payloads, payload reference event messages, etc.) as one or more topics on a streaming server. For example, a producer client may provide event message payloads (e.g., received from an event message interceptor) as an input topic to the streaming service, such that the streaming service provides the event message payloads through one or more input event streams. As another example, a producer client may provide transformed event message payloads (e.g., received from a consumer client) as an output topic to the streaming service, such that the streaming service provides the transformed event message payloads through one or more output event streams.

In some embodiments, a producer client writes transformed event message payloads (received from a consumer client) to an output topic. In some embodiments, a producer client identifies one or more potential data transmission failures associated with outsize ones of message data (e.g., one or more event message payloads or one or more transformed event message payloads) that exceed a data size limit. In some embodiments, a producer client performs exception handling of one or more data transmission failures by (i) storing the outsize ones of the one or more event message payloads or the one or more transformed event message payloads to a data storage file system and (ii) writing one or more payload reference event messages associated with the outsize ones of the one or more event message payloads or the one or more transformed event message payloads to an input topic or an output topic, respectively, wherein the one or more payload reference event messages comprise one or more file references to the outsize ones of the one or more event message payloads or the one or more transformed event message payloads in the data storage file system. The one or more file references may comprise instructions for retrieving the outsize ones of the one or more event message payloads or the one or more transformed event message payloads from the data storage file system.

In some embodiments, the term “topic” refers to a data construct that describes a type of log file or data structure used to store and logically organize messages received by a streaming server. For example, different types or categories of messages may be written to and received (or read) from respective topics. For instance, an event message payload provided as an input topic may be written to an input topic log file (and/or other data structure) of a streaming server. As another example, a transformed event message payload provided as an output topic may be written to an output topic log file (and/or other data structure) of a streaming server. As such, topics may be used to sort or group different types of messages. One or more producer clients may write messages with respect to a particular topic and one or more consumer clients may receive messages for a particular topic by subscribing to a particular topic event stream. According to various embodiments of the present disclosure, event message payloads may be written to an input topic on a streaming server by a producer client and the read from the input topic by the streaming server and provided, via an input topic stream, to one or more consumer clients.

In some embodiments, the term “topic stream” refers to a data construct that describes a data stream comprising one or more event message payloads associated with a given topic of a streaming server. For a given topic, a streaming server may generate one or more topic streams to transmit any of one or more event message payloads written to the given topic. In some embodiments, topic streams are transmitted from a streaming server and received by one or more consumer clients. A plurality of topic streams may be generated by a streaming server for streaming different types or categories of messages written to respective one or more topics associated with the one or more topic streams. According to various embodiments of the present disclosure, a streaming server is configured to (i) transmit one or more input topic streams comprising one or more event message payloads from an input topic to one or more consumer clients and (ii) transmit one or more output topic streams comprising one or more transformed event message payloads from an output topic to at least one of the one or more consumer clients.

In some embodiments, the term “streaming server” refers to computing entity, e.g., hardware, software, or a combination thereof, comprising a distributed event platform configured to receive, store, and transmit messages from one or more producer clients as streams of events. An example of a streaming server may comprise Apache KAFKA®. In some embodiments, a streaming server comprises a cluster of broker nodes distributed across a network and coupled to one or more producer clients and one or more consumer clients. According to various embodiments of the present disclosure, a streaming server receives one or more event message payloads from a producer client (e.g., via the producer client providing, writing, assigning, publishing, etc. the one or more event message payloads to the streaming server) and transmits the one or more event message payloads via topic streams to one or more consumer clients (e.g., via the one or more consumer clients reading from the input topic streams).

In some embodiments, a streaming server receives one or more transformed event message payloads from a producer client (e.g., via the producer client writing, assigning, or publishing the one or more transformed event message payloads to an output topic on the streaming server) and transmits the one or more transformed event message payloads via topic streams to one or more consumer clients (e.g., via the one or more consumer clients reading from the output topic). In some embodiments, a streaming server receives one or more payload reference event messages comprising one or more file references for retrieving outsize ones of one or more event message payloads or one or more transformed event message payloads from a data storage file system.

In some embodiments, the term “consumer client” refers to a computing entity, e.g., hardware, software, or a combination thereof, that reads (and/or receives) message data (e.g., event message payloads, transformed event message payloads, or payload reference event messages) from one or more topics on a streaming server. A consumer client may further utilize messages read from one or more topics to perform various tasks or operations. According to various embodiments of the present disclosure, a streaming server is configured to transmit one or more input topic streams (comprising one or more event message payloads) and one or more output topic streams (comprising one or more transformed event message payloads) to a first consumer client, wherein the first consumer client comprises a data repository interface configured to (i) read (and/or receive) the one or more input topic streams and the one or more output topic streams and (ii) store the one or more event message payloads from the one or more input topic streams and the one or more transformed event message payloads from the one or more output topic streams to respective first and second staging areas associated with an input topic and an output topic in a data repository. In some embodiments, a streaming server is configured to transmit one or more input topic streams (comprising one or more event message payloads) to a second consumer client, wherein the second consumer client comprises or is communicatively coupled to a transformer configured to (i) read (and/or receive) the one or more input topic streams, (ii) generate one or more transformed event message payloads by applying one or more data transformation rules to the one or more event message payloads received from the one or more input topic streams, and (iii) transmit the one or more transformed event message payloads to a producer client, wherein the producer client may write (assign or publish) the one or more transformed event message payloads to an output topic and transmit one or more output topic streams comprising the one or more transformed event message payloads from the output topic to the first consumer client.

In some embodiments, the term “transformation rule” refers to a data construct that describes a logic for changing or modifying data based on a mapping function. Transformational rules may be applied to event message payloads to generate transformed event message payloads. For example, a transformation rule may be used to filter, normalize, or conform event message payloads into a desired form, thereby generating transformed event message payloads comprising desired properties or content. In some embodiments, a transformation rule comprises one or more flattening operations that are performed on an event message payload. For example, a consumer client comprising or communicatively coupled to a transformer may dynamically apply transformation rules to event message payloads received from a streaming server to yield a flat reportable object data structure. In some embodiments, a transformation rule comprises one or more parsing rules that are defined based on a template definition language, such as a natural language-based template definition language. As an example, a transformation rule may comprise parsing logic specifying data source field names/elements and paths (e.g., FHIRpath or JSONpath) of the field names/elements specifying how to extract data from the field names/element. According to various embodiments of the present disclosure, one or more event message payloads are received from the one or more input topic streams by using one of one or more consumer clients and one or more transformed event message payloads are generated using the consumer client by applying one or more data transformation rules to the one or more event message payloads received from the one or more input topic streams.

In some embodiments, the term “transformed event message payload” refers to a data construct that describes an event message payload that has been modified based on a transformation rule. For example, a transformed event message payload may be generated by filtering, normalizing, or conforming event message payloads with desired properties or content. In some embodiments, a transformed event message payload comprises a flat reportable object data structure. A consumer client may be used to and/or configured to generate transformed event message payloads. According to various embodiments of the present disclosure, a consumer client or a transformer coupled to the consumer client is configured to (i) read (and/or receive) one or more event message payloads via one or more input topic streams from a streaming server, (ii) generate one or more transformed event message payloads by applying one or more data transformation rules to the one or more event message payloads, and (iii) transmit the one or more transformed event message payloads to a producer client, wherein the producer client may write (assign or publish) the one or more transformed event message payloads to an output topic and transmit one or more output topic streams comprising the one or more transformed event message payloads from the output topic to other ones of consumer clients.

In some embodiments, the term “data transmission failure” refers to a condition where data is unable to be transmitted from a first computing entity to a second computing entity. For example, a data transmission failure may comprise an inability of a producer client to transmit an event message payload to a streaming server. In some embodiments, data transmission failures may occur as a result of not satisfying a configuration limit, such as one based on a size of data (e.g., event message payloads) that is allowed to be written to topics of a streaming server. A streaming server may be configured to limit a maximum size of event message payloads that may be written to topics such that topic streams based on the topics would not require a large amount of bandwidth and/or computing resources to support transmission of the topic streams. According to various embodiments of the present disclosure, one or more potential data transmission failures associated with outsize ones (e.g., that exceed a maximum data size limit) of one or more event message payloads or one or more transformed event message payloads are identified. In some embodiments, if a producer client transmits an event message payload (or a transformed event message payload) that is smaller than a maximum data size limit, the event message payload (or transformed event message payload) is directly written to a topic on a streaming server, otherwise, if the event message payload (or transformed event message payload) exceeds the maximum data size limit, the event message payload (or transformed event message payload) will fail to write to the topic on the steaming server. In some embodiments, if an event message payload (or a transformed event message payload) fails to write to a topic based on the event message payload (or transformed event message payload) exceeding the maximum data size limit, exception handling is performed.

In some embodiments, the term “exception handling” refers a response to an occurrence of a condition requiring special or additional processing. Exception handling may be performed to handle failures in a production computing system, such as a data transmission failure. According to various embodiments of the present disclosure, exception handling of one or more data transmission failures is performed by (i) storing outsize ones of one or more event message payloads or one or more transformed event message payloads (associated with the one or more data transmission failures) to a data storage file system and (ii) writing one or more payload reference event messages associated with the outsize ones of the one or more event message payloads or the one or more transformed event message payloads to a streaming server, wherein the one or more payload reference event messages comprise one or more file references to the outsize ones of the one or more event message payloads or the one or more transformed event message payloads in the data storage file system.

In some embodiments, the term “data storage file system” refers to a system that stores and organizes data. A data storage file system may be configured to name, store, and retrieve data, such as event message payloads. In some embodiments, a data storage file system comprises a cloud container file system. According to various embodiments of the present disclosure, a data storage file system may be used to store one or more event message payloads or one or more transformed event message payloads that exceed a maximum data size limit and fail to be transmitted to a streaming server (e.g., data transmission failure). Payload reference event messages associated with oversized ones of event message payloads or transformed event message payloads may be generated and written to topics of a streaming server in place of the actual oversized ones of event message payloads or transformed event message payloads. Payload reference event messages may comprise file references usable by a consumer client to retrieve oversized ones of event message payloads or transformed event message payloads from a data storage file system of which the oversized ones of event message payloads or the transformed event message payloads have been stored in the data storage file system. As such, oversized ones of event message payloads or transformed event message payloads may be retrieved from a data storage file system instead of a streaming server thereby preventing bottlenecks at the streaming server.

In some embodiments, the term “payload reference event message” refers to a data construct that describes a message that refers to an event message payload or a transformed event message payload that is stored in a data storage file system. In some embodiments, a payload reference event message comprises a file reference usable to retrieve an event message payload or a transformed event message payload from a data storage file system. According to various embodiments of the present disclosure, oversized ones of one or more event message payloads or one or more transformed event message payloads are stored to a data storage file system during performance of exception handling of data transmission failures (e.g., to a streaming server) associated with the oversized ones of one or more event message payloads or one or more transformed event message payloads. During performance of the exception handling, a payload reference event message may also be generated to allow a consumer client to retrieve the oversized one of an event message payload or a transformed event message payload from the data storage file system (instead of topic streams from a streaming server).

In some embodiments, the term “file reference” refers to a data construct that describes a location of a file stored in a data storage file system. For example, a file reference may comprise a uniform resource locator (URL), an address, or a file path. In some embodiments, a file reference comprises instructions for retrieving data from a data storage file system. According to various embodiments of the present disclosure, a payload reference event message may comprise a file reference for retrieving outsize ones of one or more event message payloads or one or more transformed event message payloads from a data storage file system. In some embodiments, a consumer client comprises a single message transform plugin configured to (i) scan one or more payload reference event messages for one or more file references and (ii) receive the outsize ones of the one or more event message payloads or the one or more transformed event message payloads from the data storage file system based on the one or more file references. The single message transform plugin may comprise a declarative plugin that checks for a file reference in every event message (e.g., event message payload, transformed event message payload, or payload reference event message), retrieves the actual payload (e.g., event message payload, transformed event message payload) from a data storage file system, and transmits the actual payload to an appropriate staging area of a data repository.

### IV. Overview

Various embodiments of the present disclosure make important technical contributions to data analysis workflows that address the efficiency and performance shortcomings of existing data analysis workflows. For example, some techniques of the present disclosure improve handling of data for streaming and downstream analytics processing by decoupling a data analysis workflow from an application's traffic data pipeline of a production computing system. To do so, a data analysis workflow may be executed asynchronously from the applications traffic data pipeline in a manner that does not interfere negatively with the performance quality or response SLA of applications within an application tier of the production computing system. Some techniques of the present disclosure also improve handling and streaming of message payloads by storing larger message payloads in a data storage file system for non-streaming retrieval. As such, some of the techniques of the present disclosure prevent overwhelming of a production computing system when executing a data analysis workflow and improve the throughput and/or speed of data analysis workflows without sacrificing the performance of the applications executing within the production computing system.

Various embodiments of the present disclosure improve efficiency and performance of data analysis workflows by performing asynchronous capture and streaming of event message payloads from an applications traffic data pipeline of a production computing system, and on-the-fly transformation of the event message payloads. As described herein, event message payloads may have complex nested structures that are not optimal for running analytics on or for deriving metrics from. Although event message payloads may be necessary for performing day-to-day operations, transformed event message payloads comprising a relatively flattened data structure and selected data fields may be more appropriate for data analysis. However, the addition of a data analysis workflow to a production computing system may negatively affect the performance of downstream applications. For this reason, event message payloads may be asynchronously captured from an applications traffic data pipeline of a production computing system to generate transformed event message payloads suitable for analysis.

In accordance with various embodiments of the present disclosure, a data analysis workflow for streaming and downstream analytics processing is executed on a production computing system by performing asynchronous capture and streaming of event message payloads from an applications traffic data pipeline of the production computing system. The asynchronous capture and streaming of event message payloads are decoupled from an applications traffic data pipeline of the production computing system. As such, operations of the disclosed data analysis workflow may be executed in a separate data pipeline and prevented from hindering the performance of applications executing on the production computing system. On-the-fly transformation of data may also be performed to improve analysis of operation or performance of one or more downstream applications. Additionally, streaming of larger event message payloads may also be handled by archiving the larger event message payloads and streaming a reference to the archived larger event message payloads to reduce network bandwidth utilization for streaming the larger event message payloads.

Moreover, some of the techniques (e.g., event message payload processing techniques, transformation techniques, or large payload handling techniques) of the present disclosure may be applied to a production computing system executing both downstream applications and data analysis workflows. This, in turn, improves computational and bandwidth efficiency and/or speed of a computing system. Other technical improvements and advantages may be realized by one of ordinary skill in the art.

Examples of technologically advantageous embodiments of the present disclosure include: (i) data capturing and streaming techniques that are decoupled from an application's traffic data pipeline to prevent hindering performance of other downstream applications, (ii) on-the-fly data transformation techniques for improved analysis of operation or performance of one or more downstream applications, (iii) payload size management techniques for improving data streaming by reducing network bandwidth and/or computing resource usage, among others. Other technical improvements and advantages may be realized by one of ordinary skill in the art.

### V. Example System Operations

As indicated, various embodiments of the present disclosure make important technical contributions to data analysis workflows that address the efficiency and performance shortcomings of existing data analysis workflows. As described herein, in accordance with various embodiments of the present disclosure, a data analysis workflow for streaming and downstream analytics processing is executed on a production computing system by performing asynchronous capture and streaming of event message payloads from an applications traffic data pipeline of the production computing system. The asynchronous capture and streaming of event message payloads are decoupled from an applications traffic data pipeline of the production computing system. As such, operations of the disclosed data analysis workflow may be executed in a separate data pipeline and prevented from hindering the performance of applications executing on the production computing system. On-the-fly transformation of data may also be performed to improve analysis of operation or performance of one or more downstream applications. Additionally, streaming of larger event message payloads may also be handled by archiving the larger event message payloads and streaming a reference to the archived larger event message payloads to reduce network bandwidth utilization for streaming the larger event message payloads. The aforementioned techniques will lead to improved performance of a computing system executing both downstream applications and data analysis workflows. Accordingly, the techniques described herein improve computational and bandwidth efficiency and/or speed of a computing system.

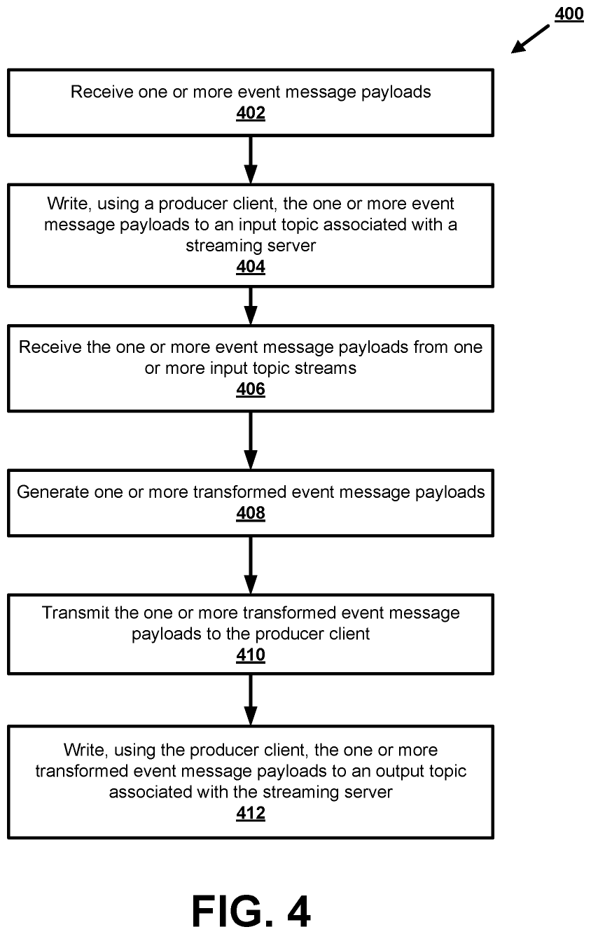

FIG. 4 is a flowchart diagram of an example process for configuring topic streams of a streaming server in accordance with some embodiments of the present disclosure.

In some embodiments, via the various steps/operations of the process 400, the data analysis computing entity 106 may use a producer client to receive one or more event message payloads associated with one or more downstream applications and provide (e.g., by publishing, writing, etc.) the one or more event message payloads to a streaming server. The one or more event message payloads may be provided as an input topic that may be provided to one or more consumer clients through one or more input event streams. The data analysis computing entity 106 may use one of the one or more consumer clients (e.g., subscribed to the one or more input event streams) to receive (e.g., consume, etc.) the event message payloads and generate one or more transformed event message payloads by applying one or more data transformation rules to the one or more event message payloads. The data analysis computing entity 106 may use the producer client to provide (e.g., by publishing, writing, etc.) the one or more transformed event message payloads to the streaming server. The one or more transformed event message payloads may be provided as an output topic that may be provided to one or more consumer clients through one or more output event streams.

In some embodiments, the process 400 begins at step/operation 402 when the data analysis computing entity 106 receives one or more event message payloads associated with one or more messages between one or more application programming interfaces and/or integrator elements and one or more downstream applications.

In some embodiments, an event message payload describes data content comprising a request or response message that is transmitted between one or more APIs or integrator elements and one or more downstream applications within an application layer. In some embodiments, an event message payload is associated with an interaction with downstream computing processes or data systems comprising various data communication channels. In one example embodiment, an event message payload is associated with a digital records system comprising electronic data records, such as EMRs and/or EHRs. In another example embodiment, an event message payload is associated with a user interface or API service associated with a digital records system. In some embodiments, an event message payload comprises a HTTP message comprising one or more HTTP headers. According to various embodiments of the present disclosure, one or more event message payloads may be received via an event message interceptor associated with an integration services application layer interface that is communicatively coupled to one or more APIs or integrator elements. According to various embodiments of the present disclosure, one or more event message payloads may be asynchronously streamed, e.g., for analysis and/or reporting, in a manner that does not interfere negatively with response SLA of one or more downstream applications in the application layer.

In some embodiments, an API or integrator element refers to intermediary components that facilitate communication between one or more upstream computing or data systems with a production computing system via an integration services application layer interface. An API or integrator element may comprise a set of definitions, rules, and/or protocols for enabling one or more upstream computing or data systems to communicate with the integration services application layer interface. Examples of an API or integrator element include, but are not limited to, graphical user interfaces, software widgets, interoperability servers, interchange processing layers, communication protocol APIs, file APIs, or any API associated with upstream computing or data systems. In some embodiments, various communication channels associated with the APIs or integrator elements may communicate with an integration services application layer interface via a standardized communication protocol data structure, such as FHIR.

In some embodiments, an integration services application layer interface refers to an interface on an application layer that is communicatively coupled to one or more APIs or integrator elements. An integration services application layer interface may exchange data with one or more APIs or integrator elements to facilitate interoperability of one or more downstream applications with one or more upstream computing or data systems (e.g., comprising one or more upstream applications). In some embodiments, the integration services application layer interface aggregates data transferred between one or more downstream applications and one or more upstream computing or data systems. In one example embodiment, an integration services application layer interface comprises an EMR EISL or a Fast Healthcare Interoperability Resources (FHIR) façade.

According to various embodiments of the present disclosure, data received by the integration services application layer interface may be captured as one or more event message payloads from the integration services application layer interface in real-time by an event message interceptor and provided to a producer client. The producer client may then provide (e.g., by writing, assigning, publishing, etc.) the one or more event message payloads to a streaming server as an input topic. In some examples, the streaming server may receive the event message payloads and forward the payload through one or more event based topic streams. The streaming server, for example, may be configured to provide one or more input topic streams (that comprises the one or more event message payloads) and/or one or more output topic streams to one or more consumer clients subscribed to at least one of the input topic streams or the output topic streams, respectively.

In some embodiments, an event message interceptor refers to software, code, or instructions that may be coupled or added to an integration services application layer interface. According to various embodiments of the present disclosure, an event message interceptor is configured to (i) intercept or capture event message payloads communicated or transmitted between the integration services application layer interface and one or more APIs or integrator elements and (ii) forward the event message payloads to a producer client.

In some embodiments, an upstream application refers to software, code, or instructions executing on an upstream computing or data system. An upstream application may be configured to perform one or more tasks, such as generating data or storing data. Data generated and/or stored by an upstream application may be used by one or more downstream applications executing on a production computing system. In some embodiments, an upstream application receives data from and/or transmits data to one or more downstream applications executing on a production computing system. In some embodiments, an upstream application may comprise a digital records system, or user interface or API service associated with the digital records system.

In some embodiments, a downstream application refers to software, code, or instructions executing on a production computing system. A downstream application may be configured to perform one or more tasks associated with data generated or stored by one or more upstream applications. In some embodiments, a downstream application interacts with one or more upstream applications via requesting data from, receiving data from, and/or transmitting data to one or more upstream computing or data systems comprising the one or more upstream applications.

In some embodiments, at step/operation 404, the data analysis computing entity 106 writes, using a producer client, the one or more event message payloads to an input topic associated with a streaming server. For example, the data analysis computing entity 106 may provide, using the producer client, the one or more event message payloads as an input topic to the streaming server. The streaming server may be configured to transmit one or more input topic streams comprising the one or more event message payloads from the input topic to one or more consumer clients (e.g., clients subscribed to the input topic streams).

In some embodiments, a producer client is a computing entity, e.g., hardware, software, or a combination thereof, that provides (e.g., by publishing, writing, etc.) data to a streaming server. A producer client, for example, may provide message data (e.g., event message payloads, transformed event message payloads, payload reference event messages, etc.) as one or more topics on a streaming server. For example, a producer client may provide event message payloads (e.g., received from an event message interceptor) as an input topic to the streaming service, such that the streaming service provides the event message payloads through one or more input event streams. As another example, a producer client may provide transformed event message payloads (e.g., received from a consumer client) as an output topic to the streaming service, such that the streaming service provides the transformed event message payloads through one or more output event streams.

In some embodiments, a topic describes a type of log file or data structure used to store and logically organize messages received by a streaming server. For example, different types or categories of messages may be written to and received (or read) from respective topics. For instance, an event message payload provided as an input topic may be written to an input topic log file (and/or other data structure) of a streaming server. As another example, a transformed event message payload provided as an output topic may be written to an output topic log file (and/or other data structure) of a streaming server. As such, topics may be used to sort or group different types of messages. One or more producer clients may write messages with respect to a particular topic and one or more consumer clients may receive messages for a particular topic by subscribing to a particular topic event stream. According to various embodiments of the present disclosure, event message payloads may be written to an input topic on a streaming server by a producer client and the read from the input topic by the streaming server and provided, via an input topic stream, to one or more consumer clients.

In some embodiments, a streaming server is to a computing entity, e.g., hardware, software, or a combination thereof, comprising a distributed event platform configured to receive, store, and transmit messages from one or more producer clients as streams of events. An example of a streaming server may comprise Apache KAFKA®. In some embodiments, a streaming server comprises a cluster of broker nodes distributed across a network and coupled to one or more producer clients and one or more consumer clients. According to various embodiments of the present disclosure, a streaming server receives one or more event message payloads from a producer client (e.g., via the producer client providing, writing, assigning, publishing, etc. the one or more event message payloads to the streaming server) and transmits the one or more event message payloads via topic streams to one or more consumer clients (e.g., via the one or more consumer clients reading from the input topic streams).

In some embodiments, a consumer client is to a computing entity, e.g., hardware, software, or a combination thereof, that consumes (e.g., receives, reads, etc.) message data (e.g., event message payloads, transformed event message payloads, payload reference event messages, etc.) from one or more topic streams provided by a streaming server. A consumer client may further utilize messages read from one or more topic streams to perform various tasks or operations. According to various embodiments of the present disclosure, a streaming server is configured to provide one or more input topic streams (comprising one or more event message payloads) to one or more consumer clients (e.g., that are subscribed to the input topic streams, etc.). For instance, some of the consumer clients may include a data repository interface configured to (i) read (and/or receive, etc.) the one or more input topic streams and (ii) store the one or more event message payloads from the one or more input topic streams to a first staging area associated with an input topic in a data repository.

In some embodiments, at step/operation 406, the data analysis computing entity 106 receives, using a consumer client of one or more consumer clients, the one or more event message payloads from the one or more input topic streams. In some embodiments, the streaming server is configured to provide the one or more input topic streams (comprising the one or more event message payloads) to one or more consumer clients. For instance, the one or more consumer clients may be subscribed to the one or more input topic streams.

In some embodiments, at step/operation 408, the data analysis computing entity 106 generates one or more transformed event message payloads by applying one or more data transformation rules to the one or more event message payloads received from the one or more input topic streams.

In some embodiments, a transformed event message payload describes an event message payload that has been modified based on a transformation rule. For example, a transformed event message payload may be generated by filtering, normalizing, or conforming event message payloads with desired properties or content. In some embodiments, a transformed event message payload includes a flat reportable object data structure. A consumer client may be used to and/or configured to generate transformed event message payloads.

In some embodiments, a transformation rule describes a logic for changing or modifying data based on a mapping function. Transformational rules may be applied to event message payloads to generate transformed event message payloads. For example, a transformation rule may be used to filter, normalize, or conform event message payloads into a desired form, thereby generating transformed event message payloads comprising desired properties or content. In some embodiments, a transformation rule comprises one or more flattening operations that are performed on an event message payload. For example, a consumer client comprising or communicatively coupled to a transformer may dynamically apply transformation rules to event message payloads received from a streaming server to yield a flat reportable object data structure. In some embodiments, a transformation rule comprises one or more parsing rules that are defined based on a template definition language, such as a natural language-based template definition language. As an example, a transformation rule may comprise parsing logic specifying data source field names/elements and paths (e.g., FHIRpath or JSONpath) of the field names/elements specifying how to extract data from the field names/element.

In some embodiments, at step/operation 410, the data analysis computing entity 106 transmits (e.g., provides, etc.), using the consumer client of the one or more consumer clients, the one or more transformed event message payloads to the producer client.

In some embodiments, at step/operation 412, the data analysis computing entity 106 writes, using the producer client, the one or more transformed event message payloads to an output topic associated with the streaming server. For example, the data analysis computing entity 106 may provide, using the producer client, the one or more transformed event message payloads as an output topic to the streaming server. In some embodiments, the producer client may transmit one or more output topic streams comprising the one or more transformed event message payloads from the output topic to another one of the one or more consumer clients. In some embodiments, a streaming server receives one or more transformed event message payloads from a producer client (e.g., via the producer client writing the one or more transformed event message payloads to an output topic on the streaming server) and transmits the one or more transformed event message payloads via one or more output topic streams to one or more consumer clients (e.g., via the one or more consumer clients reading from the output topic) subscribed to the one or more output topic streams.

Transformed event message payloads may be provided as output topics to the streaming server. For example, the transformed event message payloads may be written to an output topic on a streaming server by a producer client. The transformed event message payloads may be read from the output topic by the streaming server. The streaming server may provide the transformed event message payloads, via one or more output topic streams, to one or more subscribed consumer clients, such as one or more repository consumer clients. According to various embodiments of the present disclosure, a streaming server is configured to transmit one or more output topic streams (comprising one or more transformed event message payloads) to the one or more consumer clients. The one or more consumer clients, for example, may include a data repository interface configured to (i) read (and/or receive) the one or more output topic streams and (ii) store the one or more transformed event message payloads from the one or more output topic streams to a second staging area associated with the output topic in a data repository.

Accordingly, a plurality of topic streams may be generated by a streaming server for streaming different types or categories of messages written to respective one or more topics associated with the one or more topic streams. According to various embodiments of the present disclosure, a streaming server is configured to (i) provide or transmit one or more input topic streams comprising one or more event message payloads from an input topic to one or more consumer clients and (ii) provide or transmit one or more output topic streams comprising one or more transformed event message payloads from an output topic to at least one of the one or more consumer clients.

In some embodiments, the data analysis computing entity 106 (e.g., using the producer client, etc.) identifies one or more potential data transmission failures associated with outsize ones of message data (e.g., one or more event message payloads or one or more transformed event message payloads) that exceed a data size limit.

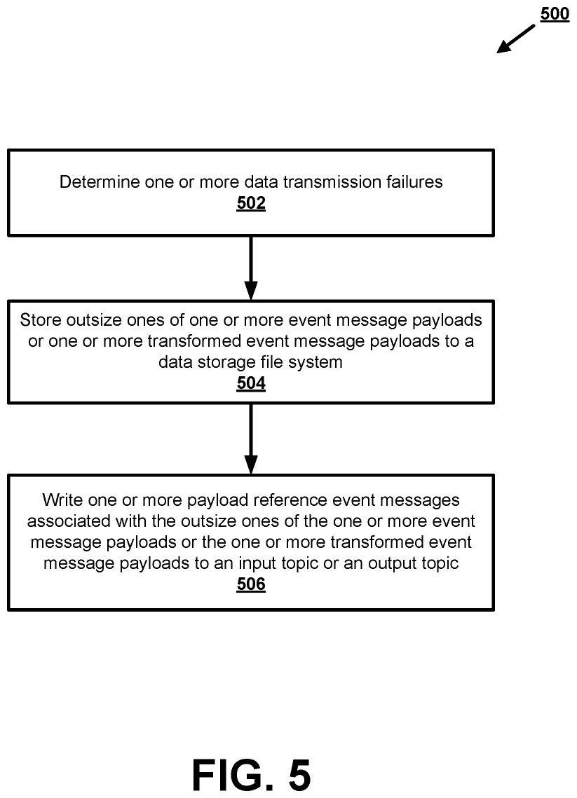

FIG. 5 is a flowchart diagram of an example process for handling outsized event message payloads in accordance with some embodiments of the present disclosure.

In some embodiments, the process 500 begins at step/operation 502 when the data analysis computing entity 106 determines one or more data transmission failures associated with outsize ones of one or more event message payloads or one or more transformed event message payloads that exceed a data size limit.

In some embodiments, a data transmission failure describes a condition where data is unable to be transmitted from a first computing entity to a second computing entity. For example, a data transmission failure may comprise an inability of a producer client to transmit an event message payload to a streaming server. In some embodiments, data transmission failures may occur as a result of not satisfying a configuration limit, such as one based on a size of data (e.g., event message payloads) that is allowed to be written to topics of a streaming server. A streaming server may be configured to limit a maximum size of event message payloads that may be written to topics such that topic streams based on the topics would not require a large amount of bandwidth and/or computing resources to support transmission of the topic streams.

According to various embodiments of the present disclosure, one or more data transmission failures associated with outsize ones (e.g., that exceed a maximum data size limit) of one or more event message payloads or one or more transformed event message payloads are determined. In some embodiments, if a producer client transmits an event message payload (or a transformed event message payload) that is smaller than a maximum data size limit, the event message payload (or transformed event message payload) is directly written to a topic on a streaming server, otherwise, if the event message payload (or transformed event message payload) exceeds the maximum data size limit, the event message payload (or transformed event message payload) will fail to write to the topic on the steaming server. In some embodiments, if an event message payload (or a transformed event message payload) fails to write to a topic based on the event message payload (or transformed event message payload) exceeding the maximum data size limit, exception handling is performed.

In some embodiments, exception handling describes a response to an occurrence of a condition requiring special or additional processing. Exception handling may be performed to handle failures in a production computing system, such as a data transmission failure.

In some embodiments, at step/operation 504, the data analysis computing entity 106 performs exception handling associated with the one or more data transmission failures by storing, using a producer client, the outsize ones of the one or more event message payloads or the one or more transformed event message payloads to a data storage file system.

In some embodiments, a data storage file system describes a system that stores and organizes data. A data storage file system may be configured to name, store, and retrieve data, such as event message payloads. In some embodiments, a data storage file system comprises a cloud container file system. According to various embodiments of the present disclosure, a data storage file system may be used to store one or more event message payloads or one or more transformed event message payloads that exceed a maximum data size limit and fail to be transmitted to a streaming server (e.g., data transmission failure).

In some embodiments, at step/operation 506, the data analysis computing entity 106 further performs exception handling associated with the one or more data transmission failures by writing, using the producer client, one or more payload reference event messages associated with the outsize ones of the one or more event message payloads or the one or more transformed event message payloads to an input topic or an output topic, respectively. For example, one or more payload reference event messages associated with the one or more event message payloads may be written to the input topic, while one or more payload reference event messages associated with the one or more transformed event message payloads may be written to the output topic. In some embodiments, the outsize ones of one or more event message payloads or one or more transformed event message payloads are read from the input topic or the output topic by (and transmitted to) one or more consumer clients via respective input topic streams and output topic streams.

Payload reference event messages associated with oversized ones of event message payloads or transformed event message payloads may be generated and written to topics of a streaming server in place of the actual oversized ones of event message payloads or transformed event message payloads.

In some embodiments, a payload reference event message describes a message that refers to an event message payload or a transformed event message payload that is stored in a data storage file system. In some embodiments, a payload reference event message comprises a file reference usable to retrieve an event message payload or a transformed event message payload from a data storage file system. According to various embodiments of the present disclosure, oversized ones of one or more event message payloads or one or more transformed event message payloads are stored to a data storage file system during performance of exception handling of data transmission failures (e.g., to a streaming server) associated with the oversized ones of one or more event message payloads or one or more transformed event message payloads. During performance of the exception handling, a payload reference event message may also be generated to allow a consumer client to retrieve the oversized one of an event message payload or a transformed event message payload from the data storage file system (instead of topic streams from a streaming server).

The one or more payload reference event messages comprise one or more file references to the outsize ones of the one or more event message payloads or the one or more transformed event message payloads in the data storage file system. In some embodiments, a file reference describes a location of a file stored in a data storage file system. For example, a file reference may comprise a uniform resource locator (URL), an address, or a file path. The one or more file references may comprise instructions for retrieving the outsize ones of the one or more event message payloads or the one or more transformed event message payloads from the data storage file system. As such, oversized ones of event message payloads or transformed event message payloads may be retrieved from a data storage file system instead of a streaming server thereby preventing bottlenecks at the streaming server.

In some embodiments, a consumer client comprises a single message transform plugin configured to (i) scan one or more payload reference event messages for one or more file references and (ii) receive the outsize ones of the one or more event message payloads or the one or more transformed event message payloads from the data storage file system based on the one or more file references. The single message transform plugin may comprise a declarative plugin that checks for a file reference in every event message (e.g., event message payload, transformed event message payload, or payload reference event message), retrieves the actual payload (e.g., event message payload, transformed event message payload) from a data storage file system, and transmits the actual payload to an appropriate staging area of a data repository.

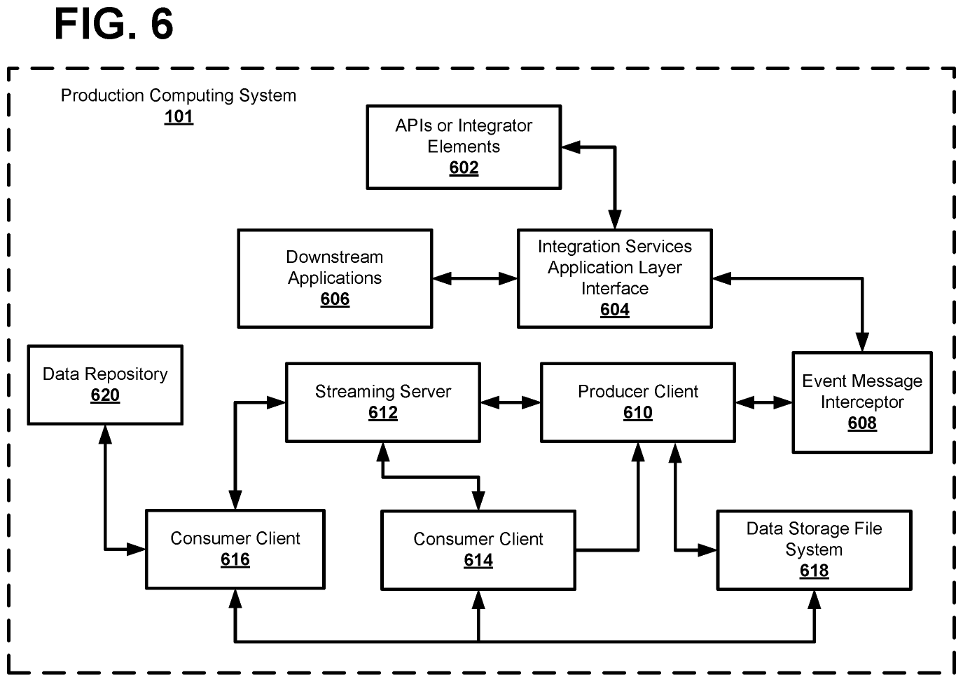

FIG. 6 depicts an operational example of a data workflow architecture in accordance with some embodiments discussed herein. Production computing system 101 further comprises a data workflow architecture, as depicted in FIG. 6. APIs or integrator elements 602 may comprise intermediary components that facilitate communication between upstream computing or data systems 104 (e.g., comprising one or more upstream applications) with production computing system 101 via integration services application layer interface 604. Integration services application layer interface 604 may exchange data with one or more APIs or integrator elements, e.g., to facilitate interoperability of downstream applications 606 with upstream computing or data systems 104. In some embodiments, the integration services application layer interface 604 aggregates data transferred between one or more downstream applications 606 and upstream computing or data systems 104. According to various embodiments of the present disclosure, data received by the integration services application layer interface 604 may be captured as one or more event message payloads from the integration services application layer interface 604 in real-time by event message interceptor 608 and transmitted to a producer client 610 for writing (assigning or publishing) to an input topic on a streaming server 612.

Streaming server 612 may transmit a variety of topic streams to consumer client 614 and consumer client 616. In some embodiments, consumer client 614 comprises or is communicatively coupled to a transformer configured to dynamically apply transformation rules to event message payloads received from streaming server 612 to yield flat reportable object data structures. For example, consumer client 614 may be configured to (i) read (and/or receive) one or more event message payloads via one or more input topic streams from streaming server 612, (ii) generate one or more transformed event message payloads by applying one or more data transformation rules to the one or more event message payloads, and (iii) transmit the one or more transformed event message payloads to producer client 610, where the producer client 610 may write the one or more transformed event message payloads to an output topic on the streaming server 612. The streaming server 612 may and transmit one or more output topic streams comprising the one or more transformed event message payloads from the output topic to consumer client 616, for example.

In some embodiments, streaming server 612 is configured to transmit one or more input topic streams (comprising one or more event message payloads) and one or more output topic streams (comprising one or more transformed event message payloads) to consumer client 616. Consumer client 616 may comprise a data repository interface configured to (i) read (and/or receive) the one or more input topic streams and the one or more output topic streams and (ii) store the one or more event message payloads from the one or more input topic streams and the one or more transformed event message payloads from the one or more output topic streams to respective first and second staging areas associated with an input topic and an output topic in a data repository 620. Event message payloads or transformed event message payloads stored in data repository 620 may be used to initiate the performance of prediction-based actions, such as generating analytics and/or predictions based on event message payloads associated with the one or more downstream applications, and displaying the analytics and/or predictions on a user interface. Other examples of prediction-based actions comprise generating a diagnostic report, displaying/providing resources, generating, and/or executing action scripts, generating alerts or reminders, or generating one or more electronic communications based on the analytics and/or predictions.

A data storage file system 618 may be used to store one or more event message payloads or one or more transformed event message payloads that exceed a maximum data size limit and fail to be transmitted to streaming server 612 (e.g., data transmission failure). According to various embodiments of the present disclosure, oversized ones of one or more event message payloads or one or more transformed event message payloads are stored to data storage file system 618 by producer client 610 during performance of exception handling of data transmission failures to streaming server 612 associated with the oversized ones of one or more event message payloads or one or more transformed event message payloads. During performance of the exception handling, a payload reference event message may also be generated by producer client 610 to allow consumer client 614 or consumer client 616 to retrieve the oversized one of an event message payload or a transformed event message payload from the data storage file system.

Payload reference event messages associated with oversized ones of event message payloads or transformed event message payloads may be generated by producer client 610 and written to topics of streaming server 612 in place of the actual oversized ones of event message payloads or transformed event message payloads. In some embodiments, consumer client 614 or consumer client 616 comprises a single message transform plugin configured to (i) scan one or more payload reference event messages for one or more file references and (ii) receive the outsize ones of the one or more event message payloads or the one or more transformed event message payloads from the data storage file system 618 based on the one or more file references.

Accordingly, as described above, various embodiments of the present disclosure make important technical contributions to data analysis workflows that address the efficiency and performance shortcomings of existing data analysis workflows. For example, some techniques of the present disclosure improve handling of data for streaming and downstream analytics processing by decoupling a data analysis workflow from an applications traffic data pipeline of a production computing system. To do so, a data analysis workflow may be executed asynchronously from the applications traffic data pipeline in a manner that does not interfere negatively with the performance quality or response SLA of applications within an application tier of the production computing system. Some techniques of the present disclosure also improve handling and streaming of message payloads by storing larger message payloads in a data storage file system for non-streaming retrieval. As such, some of the techniques of the present disclosure prevent overwhelming of a production computing system when executing a data analysis workflow and improve the throughput and/or speed of data analysis workflows without sacrificing the performance of the applications executing within the production computing system.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method comprising: receiving, by one or more processors, one or more event message payloads associated with one or more messages between one or more application programming interfaces or integrator elements and one or more downstream applications; providing, by the one or more processors and using a producer client, the one or more event message payloads as an input topic to a streaming server that is configured to provide, to one or more consumer clients, (1) one or more input topic streams that comprises the one or more event message payloads and (2) one or more output topic streams; receiving, by the one or more processors and using a consumer client of the one or more consumer clients, the one or more event message payloads from the one or more input topic streams; generating, by the one or more processors, one or more transformed event message payloads by applying one or more data transformation rules to the one or more event message payloads received from the one or more input topic streams; and providing, by the one or more processors and using the producer client, the one or more transformed event message payloads as an output topic to the streaming server.

Example 2. The computer-implemented method of any of the preceding examples, wherein the one or more consumer clients comprise another consumer client that comprises a data repository interface configured to store the one or more event message payloads from the one or more input topic streams and the one or more transformed event message payloads from the one or more output topic streams to respective first and second staging areas associated with the input topic and the output topic in a data repository.

Example 3. The computer-implemented method of any of the preceding examples further comprising identifying one or more potential data transmission failures associated with outsize ones of the one or more event message payloads or the one or more transformed event message payloads that exceed a data size limit.

Example 4. The computer-implemented method of any of the preceding examples further comprising performing exception handling of the one or more data transmission failures by: storing the outsize ones of the one or more event message payloads or the one or more transformed event message payloads to a data storage file system; and providing one or more payload reference event messages associated with the outsize ones of the one or more event message payloads or the one or more transformed event message payloads to the input topic or the output topic, respectively, wherein the one or more payload reference event messages comprise one or more file references to the outsize ones of the one or more event message payloads or the one or more transformed event message payloads in the data storage file system.

Example 5. The computer-implemented method of any of the preceding examples, wherein the one or more file references are indicative of one or more respective file locations for the outsize ones of the one or more event message payloads or the one or more transformed event message payloads from the data storage file system.

Example 6. The computer-implemented method of any of the preceding examples, wherein the one or more consumer clients comprise another consumer client that comprises a single message transform plugin configured to: determine the one or more respective file locations for the outside ones of the one or more event message payloads by scanning the one or more payload reference event messages for the one or more file references; and receive the outsize ones of the one or more event message payloads or the one or more transformed event message payloads from the data storage file system based on the one or more respective file locations.

Example 7. The computer-implemented method of any of the preceding examples, wherein the one or more data transformation rules comprise one or more parsing logics based on a natural language-based template definition language.

Example 8. The computer-implemented method of any of the preceding examples, wherein the one or more transformed event message payloads comprise one or more flat reportable object data structures.

Example 9. A computing system comprising memory and one or more processors communicatively coupled to the memory, the one or more processors configured to: receive one or more event message payloads associated with one or more messages between one or more application programming interfaces or integrator elements and one or more downstream applications; provide, using a producer client, the one or more event message payloads as an input topic to a streaming server that is configured to provide, to one or more consumer clients, (1) one or more input topic streams that comprises the one or more event message payloads and (2) one or more output topic streams; receive, using a consumer client of the one or more consumer clients, the one or more event message payloads from the one or more input topic streams; generate one or more transformed event message payloads by applying one or more data transformation rules to the one or more event message payloads received from the one or more input topic streams; and provide, using the producer client, the one or more transformed event message payloads as an output topic to the streaming server.

Example 10. The computing system of any of the preceding examples, wherein the one or more consumer clients comprise another consumer client that comprises a data repository interface configured to store the one or more event message payloads from the one or more input topic streams and the one or more transformed event message payloads from the one or more output topic streams to respective first and second staging areas associated with the input topic and the output topic in a data repository.

Example 11. The computing system of any of the preceding examples wherein the one or more processors are further configured to identify one or more potential data transmission failures associated with outsize ones of the one or more event message payloads or the one or more transformed event message payloads that exceed a data size limit.

Example 12. The computing system of any of the preceding examples wherein the one or more processors are further configured to perform exception handling of the one or more data transmission failures by: storing the outsize ones of the one or more event message payloads or the one or more transformed event message payloads to a data storage file system; and providing one or more payload reference event messages associated with the outsize ones of the one or more event message payloads or the one or more transformed event message payloads to the input topic or the output topic, respectively, wherein the one or more payload reference event messages comprise one or more file references to the outsize ones of the one or more event message payloads or the one or more transformed event message payloads in the data storage file system.

Example 13. The computing system of any of the preceding examples, wherein the one or more file references are indicative of one or more respective file locations for the outsize ones of the one or more event message payloads or the one or more transformed event message payloads from the data storage file system.

Example 14. The computing system of any of the preceding examples, wherein the one or more consumer clients comprise another consumer client that comprises a single message transform plugin configured to: determine the one or more respective file locations for the outside ones of the one or more event message payloads by scanning the one or more payload reference event messages for the one or more file references; and receive the outsize ones of the one or more event message payloads or the one or more transformed event message payloads from the data storage file system based on the one or more respective file locations.

Example 15. The computing system of any of the preceding examples, wherein the one or more data transformation rules comprise one or more parsing logics based on a natural language-based template definition language.

Example 16. The computing system of any of the preceding examples, wherein the one or more transformed event message payloads comprise one or more flat reportable object data structures.

Example 17. One or more non-transitory computer-readable storage media including instructions that, when executed by one or more processors, cause the one or more processors to: receive one or more event message payloads associated with one or more messages between one or more application programming interfaces or integrator elements and one or more downstream applications; provide, using a producer client, the one or more event message payloads as an input topic to a streaming server that is configured to provide, to one or more consumer clients, (1) one or more input topic streams that comprises the one or more event message payloads and (2) one or more output topic streams; receive, using a consumer client of the one or more consumer clients, the one or more event message payloads from the one or more input topic streams; generate one or more transformed event message payloads by applying one or more data transformation rules to the one or more event message payloads received from the one or more input topic streams; and provide, using the producer client, the one or more transformed event message payloads as an output topic to the streaming server.

Example 18. The one or more non-transitory computer-readable storage media of any of the preceding examples, wherein the one or more consumer clients comprise another consumer client that comprises a data repository interface configured to store the one or more event message payloads from the one or more input topic streams and the one or more transformed event message payloads from the one or more output topic streams to respective first and second staging areas associated with the input topic and the output topic in a data repository.

Example 19. The one or more non-transitory computer-readable storage media of any of the preceding examples further including instructions that, when executed by the one or more processors, cause the one or more processors to identify one or more potential data transmission failures associated with outsize ones of the one or more event message payloads or the one or more transformed event message payloads that exceed a data size limit.

Example 20. The one or more non-transitory computer-readable storage media of any of the preceding examples further including instructions that, when executed by the one or more processors, cause the one or more processors to perform exception handling of the one or more data transmission failures by: storing the outsize ones of the one or more event message payloads or the one or more transformed event message payloads to a data storage file system; and providing one or more payload reference event messages associated with the outsize ones of the one or more event message payloads or the one or more transformed event message payloads to the input topic or the output topic, respectively, wherein the one or more payload reference event messages comprise one or more file references to the outsize ones of the one or more event message payloads or the one or more transformed event message payloads in the data storage file system.

Example 21. The one or more non-transitory computer-readable storage media of any of the preceding examples, wherein the one or more file references are indicative of one or more respective file locations for the outsize ones of the one or more event message payloads or the one or more transformed event message payloads from the data storage file system.

Example 22. The one or more non-transitory computer-readable storage media of any of the preceding examples, wherein the one or more consumer clients comprise another consumer client that comprises a single message transform plugin configured to: determine the one or more respective file locations for the outside ones of the one or more event message payloads by scanning the one or more payload reference event messages for the one or more file references; and receive the outsize ones of the one or more event message payloads or the one or more transformed event message payloads from the data storage file system based on the one or more respective file locations.

Example 23. The one or more non-transitory computer-readable storage media of any of the preceding examples, wherein the one or more data transformation rules comprise one or more parsing logics based on a natural language-based template definition language.

Example 24. The one or more non-transitory computer-readable storage media of any of the preceding examples, wherein the one or more transformed event message payloads comprise one or more flat reportable object data structures.

1. A computer-implemented method comprising:
receiving, by one or more processors, one or more event message payloads associated with one or more messages between one or more application programming interfaces or integrator elements and one or more downstream applications;
providing, by the one or more processors and using a producer client, the one or more event message payloads as an input topic to a streaming server that is configured to provide, to one or more consumer clients, (1) one or more input topic streams that comprises the one or more event message payloads and (2) one or more output topic streams;
receiving, by the one or more processors and using a consumer client of the one or more consumer clients, the one or more event message payloads from the one or more input topic streams;
generating, by the one or more processors, one or more transformed event message payloads by applying one or more data transformation rules to the one or more event message payloads received from the one or more input topic streams; and
providing, by the one or more processors and using the producer client, the one or more transformed event message payloads as an output topic to the streaming server.

2. The computer-implemented method of claim 1, wherein the one or more consumer clients comprise another consumer client that comprises a data repository interface configured to store the one or more event message payloads from the one or more input topic streams and the one or more transformed event message payloads from the one or more output topic streams to respective first and second staging areas associated with the input topic and the output topic in a data repository.

3. The computer-implemented method of claim 1 further comprising identifying one or more potential data transmission failures associated with outsize ones of the one or more event message payloads or the one or more transformed event message payloads that exceed a data size limit.

4. The computer-implemented method of claim 3 further comprising performing exception handling of the one or more potential data transmission failures by:
storing the outsize ones of the one or more event message payloads or the one or more transformed event message payloads to a data storage file system; and
providing one or more payload reference event messages associated with the outsize ones of the one or more event message payloads or the one or more transformed event message payloads to the input topic or the output topic, respectively, wherein the one or more payload reference event messages comprise one or more file references to the outsize ones of the one or more event message payloads or the one or more transformed event message payloads in the data storage file system.

5. The computer-implemented method of claim 4, wherein the one or more file references are indicative of one or more respective file locations for the outsize ones of the one or more event message payloads or the one or more transformed event message payloads from the data storage file system.

6. The computer-implemented method of claim 4, wherein the one or more consumer clients comprise another consumer client that comprises a single message transform plugin configured to:
determine the one or more respective file locations for the outside ones of the one or more event message payloads by scanning the one or more payload reference event messages for the one or more file references; and
receive the outsize ones of the one or more event message payloads or the one or more transformed event message payloads from the data storage file system based on the one or more respective file locations.

7. The computer-implemented method of claim 1, wherein the one or more data transformation rules comprise one or more parsing logics based on a natural language-based template definition language.

8. The computer-implemented method of claim 1, wherein the one or more transformed event message payloads comprise one or more flat reportable object data structures.

9. A computing system comprising memory and one or more processors communicatively coupled to the memory, the one or more processors configured to:
receive one or more event message payloads transmitted between one or more application programming interfaces or integrator elements and one or more downstream applications;
provide, using a producer client, the one or more event message payloads as an input topic to a streaming server that is configured to provide, to one or more consumer clients, (1) one or more input topic streams that comprises the one or more event message payloads and (2) one or more output topic streams;
receive, using a consumer client of the one or more consumer clients, the one or more event message payloads from the one or more input topic streams;
generate one or more transformed event message payloads by applying one or more data transformation rules to the one or more event message payloads received from the one or more input topic streams; and
provide, using the producer client, the one or more transformed event message payloads as an output topic to the streaming server.

10. The computing system of claim 9, wherein the one or more consumer clients comprise another consumer client that comprises a data repository interface configured to store the one or more event message payloads from the one or more input topic streams and the one or more transformed event message payloads from the one or more output topic streams to respective first and second staging areas associated with the input topic and the output topic in a data repository.

11. The computing system of claim 9, wherein the one or more processors are further configured to identify one or more potential data transmission failures associated with outsize ones of the one or more event message payloads or the one or more transformed event message payloads that exceed a data size limit.

12. The computing system of claim 11, wherein the one or more processors are further configured to perform exception handling of the one or more potential data transmission failures by:
storing the outsize ones of the one or more event message payloads or the one or more transformed event message payloads to a data storage file system; and
providing one or more payload reference event messages associated with the outsize ones of the one or more event message payloads or the one or more transformed event message payloads to the input topic or the output topic, respectively, wherein the one or more payload reference event messages comprise one or more file references to the outsize ones of the one or more event message payloads or the one or more transformed event message payloads in the data storage file system.

13. The computing system of claim 12, wherein the one or more file references are indicative of one or more respective file locations for the outsize ones of the one or more event message payloads or the one or more transformed event message payloads from the data storage file system.

14. The computing system of claim 12, wherein the one or more consumer clients comprise another consumer client that comprises a single message transform plugin configured to:
determine the one or more respective file locations for the outside ones of the one or more event message payloads by scanning the one or more payload reference event messages for the one or more file references; and
receive the outsize ones of the one or more event message payloads or the one or more transformed event message payloads from the data storage file system based on the one or more respective file locations.

15. The computing system of claim 9, wherein the one or more data transformation rules comprise one or more parsing logics based on a natural language-based template definition language.

16. The computing system of claim 9, wherein the one or more transformed event message payloads comprise one or more flat reportable object data structures.

17. One or more non-transitory computer-readable storage media including instructions that, when executed by one or more processors, cause the one or more processors to:
receive one or more event message payloads transmitted between one or more application programming interfaces or integrator elements and one or more downstream applications;
provide, using a producer client, the one or more event message payloads as an input topic to a streaming server that is configured to provide, to one or more consumer clients, (1) one or more input topic streams that comprises the one or more event message payloads and (2) one or more output topic streams;
receive, using a consumer client of the one or more consumer clients, the one or more event message payloads from the one or more input topic streams;
generate one or more transformed event message payloads by applying one or more data transformation rules to the one or more event message payloads received from the one or more input topic streams; and
provide, using the producer client, the one or more transformed event message payloads as an output topic to the streaming server.

18. The one or more non-transitory computer-readable storage media of claim 17 further including instructions that, when executed by the one or more processors, cause the one or more processors to identify one or more potential data transmission failures associated with outsize ones of the one or more event message payloads or the one or more transformed event message payloads that exceed a data size limit.

19. The one or more non-transitory computer-readable storage media of claim 18 further including instructions that, when executed by the one or more processors, cause the one or more processors to perform exception handling of the one or more potential data transmission failures by:
storing the outsize ones of the one or more event message payloads or the one or more transformed event message payloads to a data storage file system; and
providing one or more payload reference event messages associated with the outsize ones of the one or more event message payloads or the one or more transformed event message payloads to the input topic or the output topic, respectively, wherein the one or more payload reference event messages comprise one or more file references to the outsize ones of the one or more event message payloads or the one or more transformed event message payloads in the data storage file system.

20. The one or more non-transitory computer-readable storage media of claim 19, wherein the one or more file references are indicative of one or more respective file locations for the outsize ones of the one or more event message payloads or the one or more transformed event message payloads from the data storage file system.
